(19) United States
(12) Patent Application Publication
(10) Pub. No.: US 2026/0227529 A1
(43) Pub. Date: Aug. 6, 2026

(54) SEQUENTIAL ARRAY OF X-RAY IMAGING DETECTORS

(71) Applicant: Sigray, Inc., Benicia, CA (US)

(72) Inventors: Wenbing YUN, Walnut Creek, CA (US); Janos KIRZ, Berkeley, CA (US); Richard Ian SPINK, Pleasant Hill, CA (US)

(21) Appl. No.: 19/399,197

(22) Filed: Nov. 24, 2025

Related U.S. Application Data
(63) Continuation of application No. 19/024,835, filed on Jan. 16, 2025, now Pat. No. 12,510,677.
(60) Provisional application No. 63/622,240, filed on Jan. 18, 2024.

(51) Int. Cl. G01T 1/16; G01T 1/20; G01T 1/29

(52) U.S. Cl. CPC G01T 1/1603; G01T 1/2008; G01T 1/20181; G01T 1/20185; G01T 1/2978

(57) ABSTRACT

An apparatus includes a plurality of x-ray imaging detectors having at least a first x-ray imaging detector and a second x-ray imaging detector. The first and second x-ray imaging detectors are configured sequentially along an x-ray beam propagation direction.

### CLAIM OF PRIORITY

This application is a continuation from U.S. application Ser. No. 19/024,835, filed Jan. 16, 2025, which claims the benefit of priority to U.S. Provisional Appl. No. 63/622,240 filed Jan. 18, 2024, which is incorporated in its entirety by reference herein.

### BACKGROUND

### Field

This application relates generally to x-ray analysis and/or imaging systems.

### Description of the Related Art

Three classes of x-ray imaging detectors are widely used. For high spatial resolution applications (e.g., resolution better than 10 microns; resolution down to sub-microns), a first class of x-ray imaging detectors utilize indirect x-ray imaging and typically comprise a scintillator screen that converts the x-ray image into an optical image, and an optical lens system (e.g., a microscope objective or a camera lens) that relays the optical image to a charge-coupled device (CCD) detector or a complementary metal-oxide-semiconductor (CMOS) camera which records the relayed optical image. This first class of x-ray imaging detectors can exhibit a low x-ray detection efficiency resulting from low x-ray stopping power of scintillator screens: thin scintillators (e.g., microns thick) with an optical lens system having a small depth-of-field, especially for high energy x-rays (e.g., x-ray energies greater than 20 keV), the optical lens system having a small field-of-view, and trade-offs between smaller pixel size and detection efficiency (e.g., higher magnification objective lenses used with smaller pixel sizes, so thinner scintillators limit the detector efficiency). In addition, the first class of x-ray imaging detectors can have a limited ability to discriminate between x-ray energies and being unable to provide angular information of the detected x-rays.

A second class of x-ray imaging detectors (e.g., generally referred to as flat panel detectors) typically comprise an x-ray scintillator material (e.g., structured CsI scintillator) or an x-ray phosphor layer (e.g., Gadox phosphor) on top of a thin film transistor array or a CMOS detector. This second class of x-ray imaging detectors can exhibit a low spatial resolution (e.g., coarser than 50 microns) and a lack of energy resolution. A third class of x-ray imaging detectors (e.g., generally referred to as hybrid photon counting detectors or direct detectors) typically comprise a photoconductor that converts x-ray signals to electrical signals. This third class of x-ray imaging detectors can exhibit low spatial resolution (e.g., coarser than 25 microns), limited ability to discriminate between x-ray energies, and being unable to provide angular information of the detected x-rays. This third class of x-ray imaging detectors can also be expensive for large pixel arrays (e.g., having more than 2000×2000 pixels and for detectors capable of hard x-ray detection).

In addition, hybrid detectors (see, e.g., U.S. Pat. No. 7,286,640B2 ) can comprise two scintillators that are upstream of a mirror that redirects the optical light to an optical lens system and then to a CCD detector. Such detectors can capture images at two different propagation distances for propagation phase contrast retrieval for biomedical applications and for enabling dual energy analysis, but they are unable to provide angular information of the detected x-rays.

### SUMMARY

In certain implementations, an apparatus comprises at least one scintillator configured to allow first x-rays of an x-ray beam incident on the at least one scintillator to propagate through the at least one scintillator and to generate visible light in response to second x-rays of the x-ray beam. The apparatus further comprises at least one optical lens system configured to allow propagation of at least a first portion of the first x-rays through the at least one optical lens system and to relay at least some of the visible light to an image plane of the at least one optical lens system. The apparatus further comprises at least one mirror configured to allow propagation of at least a second portion of the first portion of the first x-rays through the at least one mirror and to reflect at least some of the visible light from the at least one optical lens system in a direction non-parallel relative to an x-ray propagation direction of the first x-rays propagating through the at least one optical lens system and the at least one mirror. The apparatus further comprises at least one optical detector system comprising a plurality of active elements at the image plane of the at least one optical lens system and configured to receive the visible light reflected by the at least one mirror.

In certain implementations, an apparatus comprises a plurality of x-ray imaging detectors comprising at least a first x-ray imaging detector and a second x-ray imaging detector. The first and second x-ray imaging detectors are configured sequentially along an x-ray beam propagation direction.

### BRIEF DESCRIPTION OF THE DRAWINGS

FIG. 1 schematically illustrates an example apparatus in accordance with certain implementations described herein.

FIG. 2A schematically illustrates an example apparatus configured to receive an x-ray beam propagating along the x-ray propagation direction and comprising at least two type-I x-ray imaging detectors configured sequentially along the x-ray propagation direction in accordance with certain implementations described herein.

FIGS. 2B-2D schematically illustrates various example apparatus configured to receive an x-ray beam propagating along the x-ray propagation direction and comprising at least one type-I x-ray imaging detector and at least one type-II x-ray imaging detector configured sequentially along the x-ray propagation direction in accordance with certain implementations described herein.

FIG. 2E schematically illustrates an example apparatus configured to receive an x-ray beam propagating along the x-ray propagation direction and comprising at least two type-II x-ray imaging detectors configured sequentially along the x-ray propagation direction in accordance with certain implementations described herein.

FIG. 2F schematically illustrates an example apparatus comprising a plurality of x-ray imaging detectors configured sequentially along an x-ray beam propagation direction in accordance with certain implementations described herein.

### DETAILED DESCRIPTION

A high numerical aperture (NA) optical lens system (e.g., having a small depth-of-field) together with a thin scintillator with a thickness comparable to the depth-of-field is typically used to achieve high spatial resolution. However, the thin scintillator can only absorb a small fraction of the x-rays incident on the thin scintillator (e.g., the thin scintillator has a low x-ray stopping power), therefore detection efficiency can be low, especially for high energy x-rays (e.g., energies greater than 10 keV, greater than 20 keV, greater than 40 keV, or greater than 80 keV).

For higher efficiency detectors and/or higher NA optical systems with smaller working distances of the objective, the objective can be within the x-ray path (e.g., rather than the mirror). However, the objective within the x-ray path can attenuate x-rays and can distort the x-ray data collected. In certain implementations described herein, at least two detectors each comprise a scintillator and an objective coupled to (e.g., in optical communication with) one another for a relatively compact system. In certain implementations, the at least two detectors are used in combination with a flat panel detector.

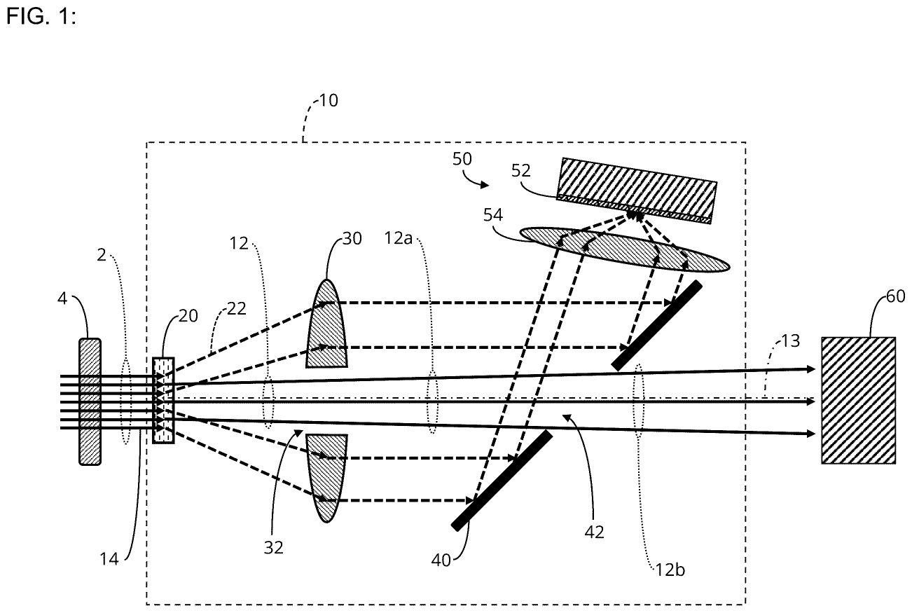

FIG. 1 schematically illustrates an example implementation of an example apparatus 10 in accordance with certain implementations described herein. The apparatus 10 comprises at least one scintillator 20 configured to allow first x-rays 12 of an x-ray beam 2 incident on the at least one scintillator 20 to propagate through the at least one scintillator 20 and generate visible light 22 in response to second x-rays 14 of the x-ray beam 2. The apparatus 10 further comprises at least one optical lens system 30 configured to allow propagation of at least a first portion 12a of the first x-rays 12 through at least one optical lens system 30 and to relay at least some of the visible light 22 to an image plane of the at least one optical lens system 30. The apparatus 10 further comprises at least one mirror 40 configured to allow propagation of at least a second portion 12b of the first portion 12a of the first x-rays 12 through the at least one mirror 40 and to reflect at least some of the visible light 22 from the at least one optical lens system 30 in a direction non-parallel relative to an x-ray propagation direction 13 of the first x-rays 12 propagating through the at least one optical lens system 30 and the at least one mirror 40. The apparatus 10 further comprises at least one optical detector system 50 comprising a plurality of active elements 52 at the image plane of the at least one optical lens system 30 and configured to receive the visible light 22 reflected by the at least one mirror 40.

As shown in FIG. 1, the apparatus 10 of certain implementations can comprise a type-I x-ray imaging detector (e.g., a detector comprising an objective lens with an aperture configured to allow x-ray transmission through the objective lens and a mirror downstream from the objective lens configured to reflect light away from the x-ray beam), while in certain other implementations, the apparatus 10 can comprise a type-II x-ray imaging detector (e.g., a detector comprising a mirror configured to allow x-ray transmission through the mirror and to reflect light away from the x-ray beam and an objective lens downstream from the mirror). In certain implementations, the x-ray beam 2 comprises an x-ray image and the at least one scintillator 12 is configured to convert the second x-rays 14 of the x-ray beam 2 to an optical image. For example, the x-ray beam 2 can comprise x-rays that have propagated through an object 4 such that the x-ray image of the x-ray beam 2 comprises structural information regarding the object 4. In certain implementations, the x-ray beam 2 is collimated (e.g., having a divergence angle less than 1 degree or less than 0.1 degree), while in certain other implementations, the x-ray beam 2 is diverging (e.g., having a divergence angle greater than 1 degree, greater than 3 degrees, or greater than 10 degrees).

In certain implementations, the at least one scintillator 20 comprises at least one scintillator material. For example, the at least one scintillator material can comprise LSO (e.g., doped with Ce) which has sufficiently strong x-ray absorption efficiency for x-rays of energies above the K absorption edge of lutetium (e.g., around 62 keV). Other example scintillator materials compatible with certain implementations described herein include but are not limited to: CaF₂, BaF₂, YAP, GdAP, LuAG, YbSO, LySO, GGG, GaGG, Lu₂O₃, YAG, LuAP, CsI, GLO, and CdWO₄ with appropriate doping. In certain implementations, the at least one scintillator material can comprise an x-ray phosphor material (e.g., Gadox).

In certain implementations, the at least one scintillator material has a thickness along the x-ray propagation direction 13 in a range of 1 micron to 500 microns (e.g., in a range of 2 microns to 40 microns; in a range of 50 microns to 500 microns) and that is configured to emit visible (e.g., optical) light 22 that includes wavelengths in a range of 300 nm to 700 nm (e.g., approximately equal to 320 nm; approximately equal to 400 nm; less than 700 nm). In certain implementations, the thickness of the at least one scintillator material is configured to provide an optical image with sufficiently high spatial resolution (e.g., the thickness is approximately equal to or less than five times of the depth-of-field of the at least one optical lens system 30). In certain implementations, the at least one scintillator material extends in at least one direction in a plane substantially perpendicular to the x-ray propagation direction 13 over an area that is approximately equal to or larger than the field-of-view of the at least one optical lens system 30 (e.g., in an area that is a range of 1× to 10× of the field-of-view of the at least one optical lens system 30). In certain implementations, the at least one scintillator material has a light yield that is sufficiently high (e.g., in a range of greater than 10 photons per keV absorbed energy) such that the apparatus 10 can obtain sufficiently high detection efficiency (e.g., greater than 5%; greater than 25%). In certain implementations, the at least one scintillator material is configured to provide a predetermined spectral response (e.g., higher absorption efficiency for a predetermined spectral region for a predetermined thickness).

In certain implementations, the at least one scintillator material and the thickness of the at least one scintillator material are configured to provide a predetermined tradeoff between spatial resolution and x-ray absorption efficiency (e.g., thin scintillators can provide higher spatial resolution while thick scintillators can provide greater x-ray absorption efficiency). In certain implementations, the at least one scintillator 20 comprises at least one substrate and the at least one scintillator material is at least one layer on the at least one substrate. The at least one substrate can have a sufficiently small thickness (e.g., along the x-ray propagation direction 13), at least over an imaging area of the at least one scintillator 20, to reduce (e.g., minimize) image background contributions to the optical image of the visible light 22 due to secondary particles (e.g., x-ray fluorescence and electrons) from interactions of the x-ray beam 2 with the at least one substrate. In certain implementations, the at least one scintillator material and the thicknesses of the at least one substrate and the at least one scintillator material are configured such that the at least one scintillator 20 has an x-ray transmission in a range of 5%-90% for x-rays having predetermined energies or energy bandwidths (e.g., greater than 5 keV; greater than 20 keV). In certain implementations, the apparatus 10 comprises a plurality of scintillators 20 with different scintillator materials and/or thicknesses and an adjustable stage (e.g., having manual or motorized control) configured to change which scintillator 20 and scintillator material is in the x-ray propagation direction 13 (e.g., by swapping amongst two or more different scintillators with different scintillator materials and/or thicknesses). In certain implementations, the at least one scintillator 20 is substantially perpendicular to the x-ray propagation direction 13, while in certain other implementations, the at least one scintillator 20 is configured to be tilted to be non-normal to the x-ray propagation direction 13, such that the at least one scintillator 20 has an increased effective thickness along the x-ray propagation direction 13 and a concomitantly increased x-ray absorption efficiency. In certain such implementations, the at least one optical lens system 30 is also tilted correspondingly relative to the x-ray propagation direction 13, such that the depth-of-focus is not increased and the spatial resolution is not degraded (e.g., avoiding a trade-off between x-ray absorption efficiency and spatial resolution).

In certain implementations, the at least one optical lens system 30 is downstream from the at least one scintillator 20 and is configured to form an enlarged optical image from the visible light 22. For example, the at least one optical lens system 30 can have a predetermined numerical aperture (NA) sufficient to obtain a predetermined spatial resolution (e.g., in a range of 0.1 to 0.9; in a range of 0.2 to 0.6) of the visible light 22 emitted by the at least one scintillator 20. In certain implementations, the NA is selected based on at least one of: the maximum resolution to be achieved, the depth-of-field to be used, and/or considerations for efficient collection of the visible light 22 generated in the at least one scintillator 20 (e.g., when used for low energy x-ray imaging applications).

In certain implementations, the at least one optical lens system 30 comprises a microscope objective. For example, the microscope objective can comprise a reflective microscope objective that is achromatic over a sufficiently wide spectral range (e.g., wavelengths from 200 nm to 10 microns) and is compatible with predetermined scintillator materials configured to generate visible light 22 having predetermined wavelengths (e.g., the microscope objective is achromatic over a spectral range that includes the wavelengths of the visible light 22 emitted by the predetermined scintillator materials). Example microscope objectives compatible with certain implementations described herein include but are not limited to: microscope objectives with magnification in a range of 2× to 100× (e.g., in a range of 4× to 40×) and a field number greater than 18 mm (e.g., greater than 20 mm; greater than 24 mm). In certain implementations, the optical lens system 30 comprises a lens (e.g., camera lens). Example microscope objectives compatible with certain implementations described herein include but are not limited to: Nikor lens series available from Nikon Corp. with an f-number smaller than 2.8 (e.g., smaller than 2; smaller than 1.4).

In certain implementations, the at least one optical lens system 30 (e.g., type-I) comprises at least one x-ray transmissive region 32 (e.g., at least one aperture or hole; pupil) configured to allow propagation of the first portion 12a of the first x-rays 12 through the at least one optical lens system 30. As shown in FIG. 1, the at least one x-ray transmissive region 32 can be positioned in a central region of the at least one optical lens system 30. For example, the at least one x-ray transmissive region 32 can comprise a hole that is machined through the microscope objective and/or the lens having sufficient width (e.g., diameter) in at least one direction substantially perpendicular to the x-ray propagation direction 13 to allow the first portion 12a of the first x-rays 12 to propagate therethrough. The width (e.g., diameter) of the hole can correspond to less than one-half of the NA of the at least one optical lens system 30.

In certain implementations, the at least one mirror 40 is downstream from the at least one optical lens system 30 (e.g., between the at least one optical lens system 30 and the image plane of the at least one optical lens system 30) and is configured to reflect the visible light 22 received from the at least one optical lens system 30 (e.g., and the image plane of the at least one optical lens system 30) at a non-zero angle relative to the x-ray propagation direction 13 (e.g., to reflect the visible light 22 and the image plane out of the x-ray beam path of the first portion 12a of the x-ray beam 12).

In certain implementations, the at least one mirror 40 comprises a solid mirror comprising at least one solid material that is at least partially opaque to and at least partially reflective of the visible light 22 impinging the at least one mirror 40. For example, the at least one mirror 40 can comprise an aluminized microscope cover slip comprising glass or sapphire (e.g., having a thickness in a range of 100 micros to 200 microns).

In certain implementations, the at least one mirror 40 comprises at least one x-ray transmissive region 42 (e.g., at least one aperture, hole, or pupil; a solid portion sufficiently thin to allow at least 20% of the incident x-rays within a predetermined spectral region of the x-ray beam 2 to propagate therethrough) configured to allow propagation of the second portion 12b of the first portion 12a of the first x-rays 12 through the at least one mirror 40 (e.g., the at least one x-ray transmissive region 42 aligned with the first portion 12a of the x-ray beam 12 passing through the at least one optical lens system 30). The x-ray transmissive region 42 can have an x-ray transmission for a predetermined spectral region of the x-ray beam 2 that is greater than 20% (e.g., greater than 50%; greater than 90%). As shown in FIG. 1, the at least one x-ray transmissive region 42 can be positioned in a central region of the at least one mirror 40. For example, the at least one x-ray transmissive region 42 can comprise a hole that is machined a solid mirror 40 and has sufficient width (e.g., diameter) in at least one direction substantially perpendicular to the x-ray propagation direction 13 to allow the second portion 12b to propagate therethrough. For another example, the at least one mirror 40 can comprise a plurality of mirrors 40 arranged (e.g., substantially symmetrically) about (e.g., around) the x-ray propagation direction 13 with the at least one x-ray transmissive region 42 therebetween. For still another example, the at least one x-ray transmissive region 42 can comprise an x-ray transmissive material selected from the group consisting of: elements with atomic numbers smaller than 15 and can have a thickness in a range of less than 4 mm (e.g., less than 1 mm; less than 0.1 mm). The width (e.g., diameter) of the at least one x-ray transmissive region 42 can be approximately equal to or larger than the at least one x-ray transmissive region 32 of the at least one optical lens system 30.

In certain implementations, the at least one optical detector system 50 comprises an optical camera (e.g., CCD camera; CMOS camera) and the plurality of active elements 52 are at the reflected image plane of the at least one optical lens system 30. In certain implementations, as shown in FIG. 1, the at least one optical detector system 50 can further comprise at least one lens 54 (e.g., tube lens) configured to receive and focus the visible light 22 reflected from the at least one mirror 40 onto the plurality of active elements 52. The at least one optical detector system 50 can be configured to record the detected optical image from the visible light 22. In certain implementations, the at least one optical detector system 50 has a predetermined spectral response (e.g., optimized to the emission spectrum of the at least one scintillator 20).

In certain implementations, the apparatus 10 further comprises an x-ray detector system 60 (e.g., one or more type-I x-ray imaging detectors) configured to receive and use (e.g., for imaging) at least some of the x-rays of the second portion 12b that propagate through the at least one mirror 40. For example, as shown in FIG. 1, the x-ray detector system 60 can be positioned sequentially along the x-ray propagation direction 13 (e.g., downstream from the at least one mirror 40). Examples of the x-ray detector system 60 can include, but are not limited to: a scintillator and an optical lens that does not have a hole or aperture (e.g., the x-ray detector system 60 is not configured to transmit x-rays); an x-ray camera; a flat panel detector; a pixel array photon counting detector; an amorphous Se pixel array detector. For example, a flat panel detector of the x-ray detector system 60 can comprise single-crystal, high efficiency scintillator microstructures having a thickness (e.g., greater than or equal to 150 microns; in a range of 150 microns to 500 microns; greater than or equal to 500 microns), configured to reduce (e.g., minimize) scattering or other factors that can otherwise degrade spatial resolution.

### Example Implementations

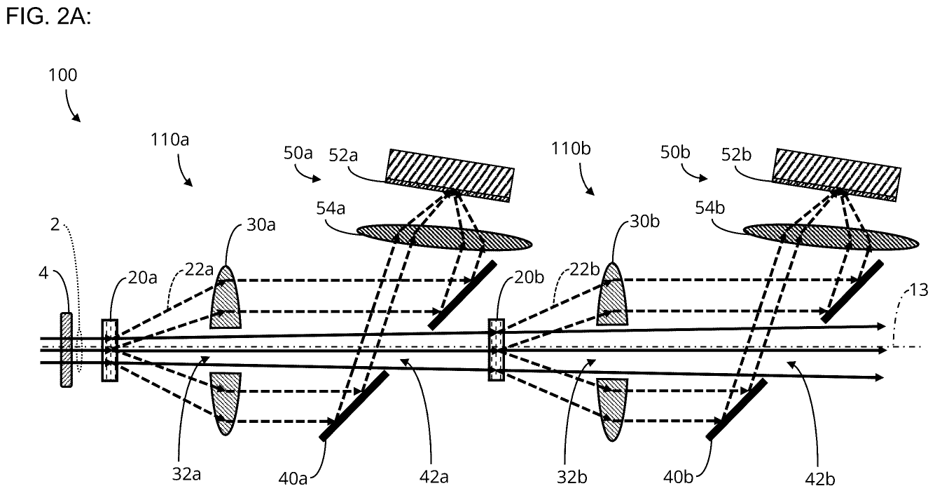

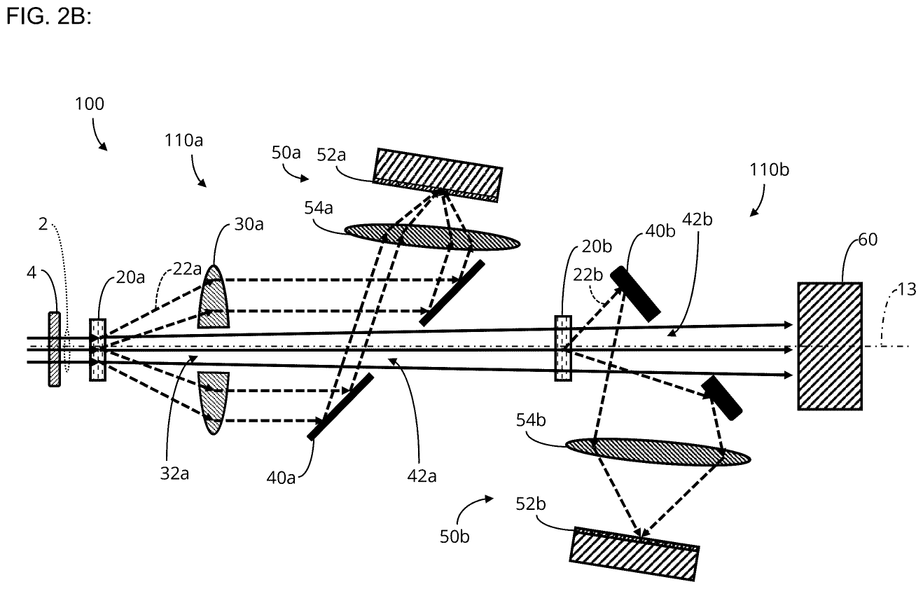

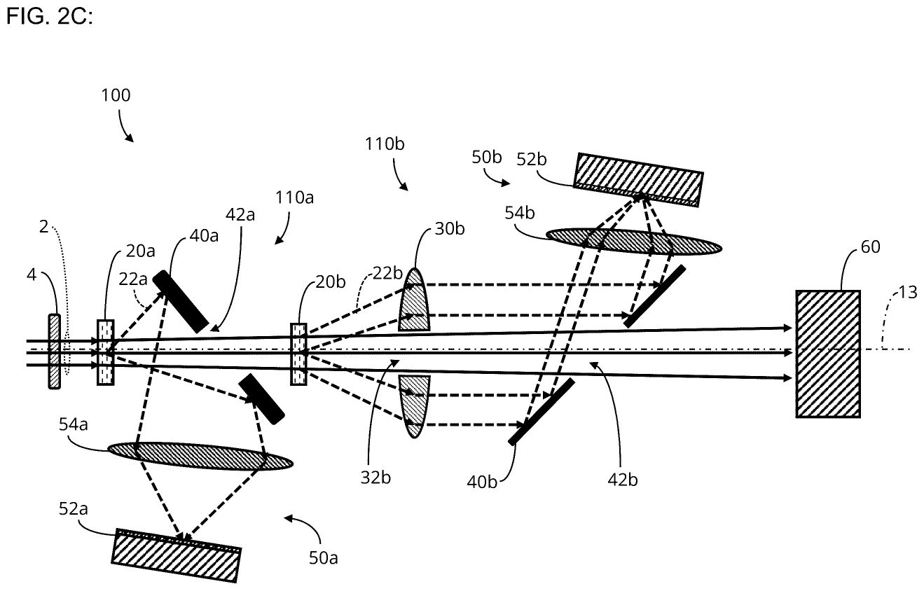

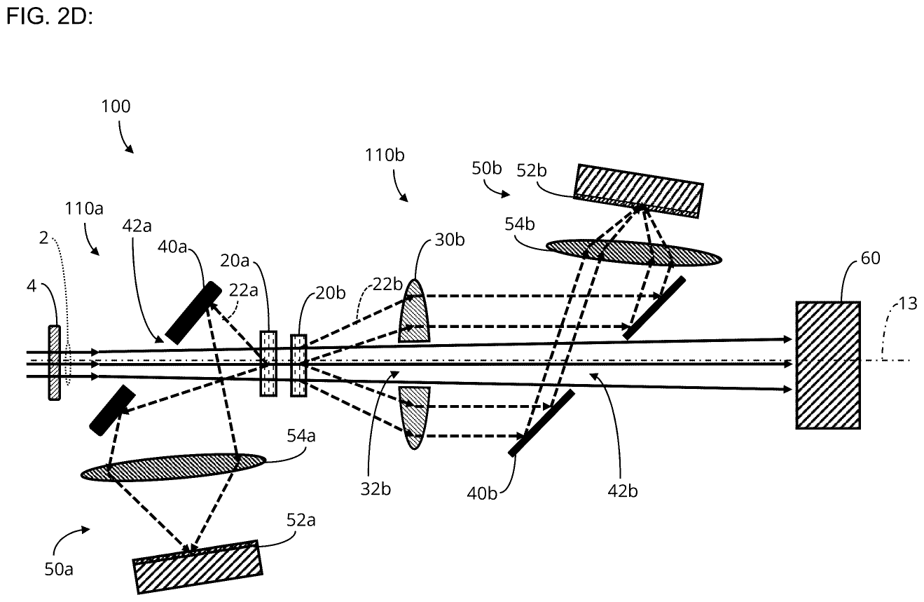

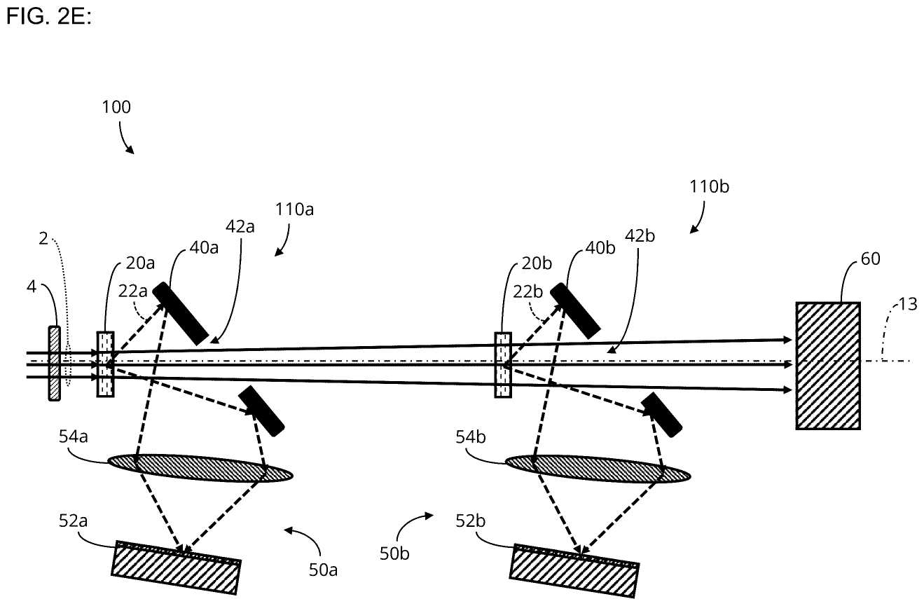

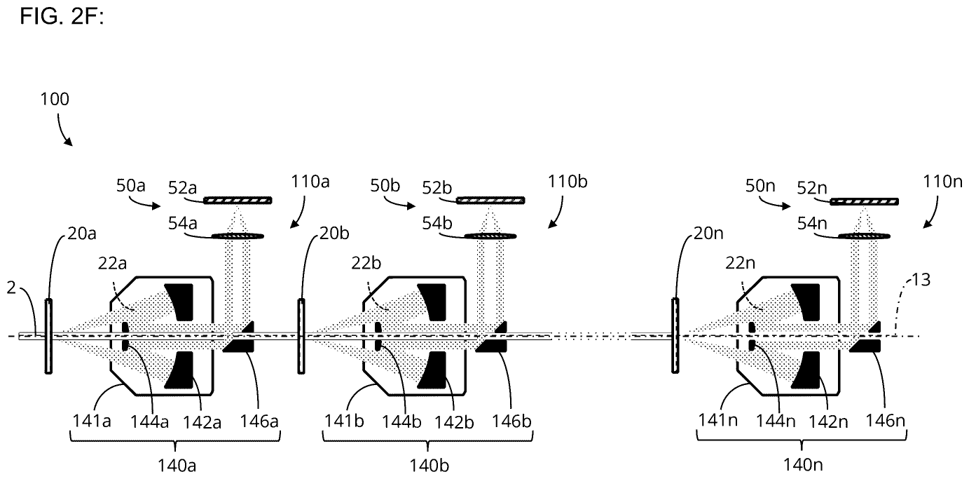

FIGS. 2A-2F schematically illustrate various example apparatus 100 in accordance with certain implementations described herein. Each of the example apparatus 100 of FIGS. 2A-2F comprises a plurality of x-ray imaging detectors 110 sequentially arranged along an x-ray propagation direction 13. For example, the plurality (e.g., array) of x-ray imaging detectors 110 can comprise at least a first x-ray imaging detector 110a and a second x-ray imaging detector 110b, the first and second x-ray imaging detectors 110a,b configured sequentially along the x-ray beam propagation direction 13 (e.g., the second x-ray imaging detector 110b downstream from the first x-ray imaging detector 110a).

In certain implementations, each x-ray imaging detector 110 of the plurality of x-ray imaging detectors 110 is configured to provide a spatial resolution finer than 25 microns (e.g., less than 10 microns; less than 2 microns; less than 1 micron). In certain implementations, the plurality of x-ray imaging detectors 110 comprises at least two (e.g., more than 2; more than 5, more than 10) x-ray imaging detectors 110 configured to achieve sufficiently high x-ray detection efficiency to facilitate x-ray imaging applications with x-rays having energies greater than 15 keV (e.g., greater than 30 keV; greater than 60 keV). Certain such implementations can facilitate optimizing resolution and detector efficiency and/or x-ray spectral response by selecting appropriate scintillator materials. In certain implementations, the first x-ray imaging detector 110a has a first field-of-view and the second x-ray imaging detector 110b has a second field-of-view, and a ratio of the first field-of-view to the second field-of-view is in a range of 1 to 50 and/or a ratio of the second field-of-view to the first field-of-view is in a range of 1 to 50.

FIG. 2A schematically illustrates an example apparatus 100 configured to receive an x-ray beam 2 propagating along the x-ray propagation direction 13 and comprising at least two type-I x-ray imaging detectors configured sequentially along the x-ray propagation direction 13 in accordance with certain implementations described herein. As shown in FIG. 2A, the first x-ray imaging detector 110a (e.g., a type-I x-ray imaging detector) comprises a first scintillator 20a, a first optical lens system 30a (e.g., downstream from the first scintillator 20a), a first mirror 40a (e.g., downstream from the first optical lens system 30a), and a first optical detector system 50a. The first scintillator 20a is configured to be irradiated by an x-ray beam 2 propagating along an x-ray propagation direction 13, to generate first visible light 22a in response to at least some of the x-rays of the x-ray beam 2 (e.g., a first fraction of the x-rays incident on the first scintillator 20a), and to allow at least some x-rays of the x-ray beam 2 to propagate through the first scintillator 20a. The first optical lens system 30a is configured to receive at least some of the first visible light 22a from the first scintillator 20a and to allow at least some x-rays of the x-ray beam 2 that propagate through the first scintillator 20a to propagate through the first optical lens system 30a. For example, the first optical lens system 30a can comprise a first x-ray transmissive region 32a (e.g., a first aperture, hole, or pupil) having a width substantially perpendicular to the x-ray propagation direction 13 and in the range of 0.3 millimeter to 40 millimeters (e.g., in a range of 0.5 millimeter to 6 millimeters; in a range of 5 millimeters to 20 millimeters). The first mirror 40 a is configured to reflect at least some of the first visible light 22a from the first optical lens system 30a in a first direction non-parallel relative to the x-ray propagation direction 13 and to allow at least some x-rays of the x-ray beam 2 that propagate through the first optical lens system 30a to propagate through the first mirror 40a. For example, the first mirror 40a can comprise a second x-ray transmissive region 42a (e.g., a second aperture, hole, or pupil; a solid portion sufficiently thin to allow at least 20% of the incident x-rays within a predetermined spectral region of the x-ray beam 2 to propagate therethrough) having a width substantially perpendicular to the x-ray propagation direction 13 and in the range of 0.3 millimeter to 40 millimeters (e.g., in a range of 0.5 millimeter to 6 millimeters; in a range of 5 millimeters to 20 millimeters). The first optical detector system 50a (e.g., comprising a first camera 52a and a first lens 54a configured to receive and focus the first visible light 22a from the first mirror 40a onto the first camera 52a) is configured to receive the first visible light 22a reflected by the first mirror 40a and to generate a first image in response to the received first visible light 22a.

As shown in FIG. 2A, the second x-ray imaging detector 110b (e.g., a type-I x-ray imaging detector) comprises a second scintillator 20b, a second optical lens system 30b (e.g., downstream from the second scintillator 20b), a second mirror 40b (e.g., downstream from the second optical lens system 30b), and a second optical detector system 50b. The second scintillator 20b is configured to be irradiated by the x-rays of the x-ray beam 2 that propagate through the first mirror 40a, to generate second visible light 22b in response to at least some of the x-rays of the x-ray beam 2 (e.g., a second fraction of the x-rays incident on the second scintillator 20b), and to allow at least some x-rays of the x-ray beam 2 to propagate through the second scintillator 20b. The second optical lens system 30b is configured to receive at least some of the second visible light 22b from the second scintillator 20b and to allow at least some x-rays of the x-ray beam 2 that propagate through the second scintillator 20b to propagate through the second optical lens system 30b. For example, the second optical lens system 30b can comprise a third x-ray transmissive region 32b (e.g., a third aperture, hole, or pupil) having a width substantially perpendicular to the x-ray propagation direction 13 and in the range of 0.3 millimeter to 40 millimeters (e.g., in a range of 0.5 millimeter to 6 millimeters; in a range of 5 millimeters to 20 millimeters). The second mirror 40b is configured to reflect at least some of the second visible light 22b from the second optical lens system 30b in a second direction non-parallel relative to the x-ray propagation direction 13 and to allow at least some x-rays of the x-ray beam 2 that propagate through the second optical lens system 30b to propagate through the second mirror 40b. For example, the second mirror 40b can comprise a fourth x-ray transmissive region 42b (e.g., a fourth aperture, hole, or pupil; a solid portion sufficiently thin to allow at least 20% of the incident x-rays within a predetermined spectral region of the x-ray beam 2 to propagate through) having a width substantially perpendicular to the x-ray propagation direction 13 and in the range of 0.3 millimeter to 40 millimeters (e.g., in a range of 0.5 millimeter to 6 millimeters; in a range of 5 millimeters to 20 millimeters). The second optical detector system 50b (e.g., comprising a second camera 52b and a second lens 54b configured to receive and focus the second visible light 22b from the second mirror 40b onto the second camera 52b) is configured to receive the second visible light 22b reflected by the second mirror 40b and to generate a second image in response to the received second visible light 22b.

While FIG. 2A shows that each of the first scintillator 20a and the second scintillator 20b is substantially perpendicular to the x-ray propagation direction 13, in certain other implementations, at least one of the first and second scintillators 20a,b is configured to be tilted to be non-normal to the x-ray propagation direction 13 (e.g., with the respective first and/or second optical lens system 30a,b also tilted correspondingly relative to the x-ray propagation direction 13). In certain implementations, the first scintillator 20a and the second scintillator 20b comprise different scintillating materials from one another (e.g., visible light 22a, 6 emitted from the first and second scintillators 20a,b, respectively, have different spectral ranges from one another). In certain implementations, as shown in FIG. 2A, the first mirror 40a and the second mirror 40b reflect the first visible light 22a and the second visible light 22b, respectively, in first and second directions, respectively, that are substantially parallel to one another (e.g., the reflected first visible light 22a and the reflected second visible light 22b are at substantially equal non-zero angles relative to the x-ray propagation direction 13) and the first optical detector system 50a and the second optical detector system 50b are positioned at the same side of the x-ray propagation direction 13 (e.g., at substantially the same azimuthal angle about the x-ray propagation direction 13). In certain other implementations, the first mirror 40a and the second mirror 40b reflect the first visible light 22a and the second visible light 22b, respectively, in first and second directions, respectively, that are different from one another (e.g., that are not substantially parallel to one another; the reflected first visible light 22a and the reflected second visible light 22b are at substantially different non-zero angles relative to the x-ray propagation direction 13) and/or the first optical detector system 50a and the second optical detector system 50b are positioned at different azimuthal angles about (e.g., different sides of) the x-ray propagation direction 13.

Each of FIGS. 2B-2D schematically illustrates an example apparatus 100 configured to receive an x-ray beam 2 propagating along the x-ray propagation direction 13 and comprising at least one type-I x-ray imaging detector and at least one type-II x-ray imaging detector configured sequentially along the x-ray propagation direction 13 in accordance with certain implementations described herein. As shown in FIGS. 2B-2D, in certain implementations, the at least one type-II x-ray imaging detector is downstream from the at least one type-I x-ray imaging detector, while in certain other implementations, the at least one type-I x-ray imaging detector is downstream from the at least one type-II x-ray imaging detector. Although each of the example apparatus 100 shown in FIGS. 2A-2D comprises only two x-ray imaging detectors 100a,b, other implementations can comprise more than two x-ray imaging detectors (e.g., comprising at least two type-I x-ray imaging detectors and at least one type-II x-ray imaging detector or comprising at least one type-I x-ray imaging detector and at least two type-II x-ray imaging detectors) configured sequentially along the x-ray beam propagation direction 13.

As shown in FIG. 2B, the first x-ray imaging detector 110a (e.g., a type-I x-ray imaging detector) can comprise a first scintillator 20a, a first optical lens system 30a (e.g., downstream from the first scintillator 20a), a first mirror 40a (e.g., downstream from the first optical lens system 30a), and a first optical detector system 50a. The first scintillator 20a can be configured to be irradiated by an x-ray beam 2 propagating along an x-ray propagation direction 13, to generate first visible light 22a in response to at least some of the x-rays of the x-ray beam 2 (e.g., a first fraction of the x-rays incident on the first scintillator 20a), and to allow at least some x-rays of the x-ray beam 2 to propagate through the first scintillator 20a. The first optical lens system 30a can be configured to receive at least some of the first visible light 22a from the first scintillator 20a and to allow at least some x-rays of the x-ray beam 2 that propagate through the first scintillator 20a to propagate through the first optical lens system 30a. For example, the first optical lens system 30a can comprise a first x-ray transmissive region 32a (e.g., a first aperture, hole, or pupil) having a width substantially perpendicular to the x-ray propagation direction 13 and in the range of 0.3 millimeter to 40 millimeters (e.g., in a range of 0.5 millimeter to 6 millimeters; in a range of 5 millimeters to 20 millimeters). The first mirror 40 a can be configured to reflect at least some of the first visible light 22a from the first optical lens system 30a in a first direction non-parallel relative to the x-ray propagation direction 13 and to allow at least some x-rays of the x-ray beam 2 that propagate through the first optical lens system 30a to propagate through the first mirror 40a. For example, the first mirror 40a can comprise a second x-ray transmissive region 42a (e.g., a second aperture, hole, or pupil; a solid portion sufficiently thin to allow at least 20% of the incident x-rays within for a predetermined spectral region of the x-ray beam 2 to propagate therethrough) having a width substantially perpendicular to the x-ray propagation direction 13 and in the range of 0.3 millimeter to 40 millimeters (e.g., in a range of 0.5 millimeter to 6 millimeters; in a range of 5 millimeters to 20 millimeters). The first optical detector system 50a (e.g., comprising a first camera 52a and a first lens 54a configured to receive and focus the first visible light 22a from the first mirror 40a onto the first camera 52a) can be configured to receive the first visible light 22a reflected by the first mirror 40a and to generate a first image in response to the received first visible light 22a.

As shown in FIG. 2B, the second x-ray imaging detector 110b (e.g., a type-II x-ray imaging detector) can comprise a second scintillator 20b, a second mirror 40b (e.g., downstream from the second scintillator 20b), and a second optical detector system 50b. The second scintillator 20b can be configured to be irradiated by the x-rays of the x-ray beam 2 that propagate through the first mirror 40a, to generate second visible light 22b in response to at least some of the x-rays of the x-ray beam 2 (e.g., a second fraction of the x-rays incident on the second scintillator 20b), and to allow at least some x-rays of the x-ray beam 2 to propagate through the second scintillator 20b. The second mirror 40b can be configured to reflect at least some of the second visible light 22b from the second scintillator 20b in a second direction non-parallel relative to the x-ray propagation direction 13 and to allow at least some x-rays of the x-ray beam 2 that propagate through the second scintillator 20b to propagate through the second mirror 40b. For example, the second mirror 40b can comprise a third x-ray transmissive region 42b (e.g., a third aperture, hole, or pupil; a solid portion sufficiently thin to allow at least 20% of the incident x-rays within a predetermined spectral region of the x-ray beam 2 to propagate therethrough) having a width substantially perpendicular to the x-ray propagation direction 13 and in the range of 0.3 millimeter to 40 millimeters (e.g., in a range of 0.5 millimeter to 6 millimeters; in a range of 5 millimeters to 20 millimeters). The second optical detector system 50b (e.g., comprising a second camera 52b and a second lens 54b configured to receive and focus the second visible light 22b from the second mirror 40b onto the second camera 52b) can be configured to receive the second visible light 22b reflected by the second mirror 40b and to generate a second image in response to the received second visible light 22b. While FIG. 2A shows that each of the first scintillator 20a and the second scintillator 20b is substantially perpendicular to the x-ray propagation direction 13, in certain other implementations, at least one of the first and second scintillators 20a,b is configured to be tilted to be non-normal to the x-ray propagation direction 13.

As shown in FIGS. 2C and 2D, the first x-ray imaging detector 110a (e.g., a type-II x-ray imaging detector) can comprise a first scintillator 20a, a first mirror 40a, and a first optical detector system 50a. The first scintillator 20a can be configured to be irradiated by the x-rays of the x-ray beam 2, to generate first visible light 22a in response to at least some of the x-rays of the x-ray beam 2 (e.g., a first fraction of the x-rays incident on the first scintillator 20a), and to allow at least some x-rays of the x-ray beam 2 to propagate through the first scintillator 20a. The first mirror 40a can be configured to reflect at least some of the first visible light 22a from the first scintillator 20a in a first direction non-parallel relative to the x-ray propagation direction 13 and to allow at least some x-rays of the x-ray beam 2 that propagate through the first scintillator 20a to propagate through the first mirror 40a. For example, the first mirror 40a can comprise a first x-ray transmissive region 42a (e.g., an aperture, hole, or pupil; a solid portion sufficiently thin to allow at least 20% of the incident x-rays within a predetermined spectral region of the x-ray beam 2 to propagate therethrough) having a width substantially perpendicular to the x-ray propagation direction 13 and in the range of 0.3 millimeter to 40 millimeters (e.g., in a range of 0.5 millimeter to 6 millimeters; in a range of 5 millimeters to 20 millimeters). The first optical detector system 50a (e.g., comprising a first camera 52a and a first lens 54a configured to receive and focus the first visible light 22a from the first mirror 40a onto the first camera 52a) can be configured to receive the first visible light 22a reflected by the first mirror 40a and to generate a first image in response to the received first visible light 22a.

As shown in FIGS. 2C and 2D, the second x-ray imaging detector 110b (e.g., a type-I x-ray imaging detector) can comprise a second scintillator 20b, an optical lens system 30b (e.g., downstream from the first scintillator 20b), a second mirror 40b (e.g., downstream from the optical lens system 30b), and a second optical detector system 50b. The second scintillator 20b can be configured to be irradiated by the portion of the x-ray beam 2 propagating along the x-ray propagation direction 13 through the first x-ray transmissive region 42a, to generate second visible light 22b in response to at least some of the x-rays of the x-ray beam 2 (e.g., a second fraction of the x-rays incident on the second scintillator 20b), and to allow at least some x-rays of the x-ray beam 2 to propagate through the second scintillator 20b. The optical lens system 30b can be configured to receive at least some of the second visible light 22b from the second scintillator 20b and to allow at least some x-rays of the x-ray beam 2 that propagate through the second scintillator 20b to propagate through the optical lens system 30b. For example, the optical lens system 30b can comprise a second x-ray transmissive region 32b (e.g., a second aperture, hole, or pupil) having a width substantially perpendicular to the x-ray propagation direction 13 and in the range of 0.3 millimeter to 40 millimeters (e.g., in a range of 0.5 millimeter to 6 millimeters; in a range of 5 millimeters to 20 millimeters). The second mirror 40b can be configured to reflect at least some of the second visible light 22b from the optical lens system 30b in a second direction non-parallel relative to the x-ray propagation direction 13 and to allow at least some x-rays of the x-ray beam 2 that propagate through the optical lens system 30b to propagate through the second mirror 40b. For example, the second mirror 40b can comprise a third x-ray transmissive region 42 b (e.g., a third aperture, hole, or pupil; a solid portion sufficiently thin to allow at least 20% of the incident x-rays within a predetermined spectral region of the x-ray beam 2 to propagate therethrough) having a width substantially perpendicular to the x-ray propagation direction 13 and in the range of 0.3 millimeter to 40 millimeters (e.g., in a range of 0.5 millimeter to 6 millimeters; in a range of 5 millimeters to 20 millimeters). The second optical detector system 50b (e.g., comprising a second camera 52b and a second lens 54b configured to receive and focus the second visible light 22b from the second mirror 40b onto the second camera 52b) can be configured to receive the second visible light 22b reflected by the second mirror 40b and to generate a second image in response to the received second visible light 22b. While FIG. 2A shows that each of the first scintillator 20a and the second scintillator 20b is substantially perpendicular to the x-ray propagation direction 13, in certain other implementations, at least one of the first and second scintillators 20a,b is configured to be tilted to be non-normal to the x-ray propagation direction 13.

As shown in FIG. 2C, the first mirror 40a is downstream from the first scintillator 20a, while in certain other implementations, as shown in FIG. 2D, the first mirror 40a is upstream from the first scintillator 20a and the first scintillator 20a is irradiated by at least some of the x-rays of the x-ray beam 2 that propagate through the first x-ray transmissive region 42a of the first mirror 40a. In certain implementations, as shown in FIG. 2D, the first scintillator 20a and the second scintillator 20b can be adjacent to one another. The apparatus 100 can comprise a light blocker (not shown) between the first and second scintillators 20a,b that is optically opaque but is transmissive to the x-rays of the x-ray beam 2 (e.g., x-ray transmission greater than 20% for x-rays having energies greater than 5 keV). For example, the light blocker can comprise a thin graphite plate or a plastic film coated with a carbon layer or a thin Al layer.

FIG. 2E schematically illustrates an example apparatus 100 configured to receive an x-ray beam 2 propagating along the x-ray propagation direction 13 and comprising at least two type-II x-ray imaging detectors configured sequentially along the x-ray propagation direction 13 in accordance with certain implementations described herein. As shown in FIG. 2E, the first x-ray imaging detector 110a (e.g., a type-II x-ray imaging detector) can comprise a first scintillator 20a, a first mirror 40a, and a first optical detector system 50a, as described herein with regard to FIGS. 2C and 2D, and the second x-ray imaging detector 110b (e.g., a type-II x-ray imaging detector) can comprise a second scintillator 20b, a second mirror 40b (e.g., downstream from the second scintillator 20b), and a second optical detector system 50b, as described herein with regard to FIG. 2B. While FIG. 2E shows the first mirror 40a is downstream from the first scintillator 20a and the second mirror 40b is downstream from the second scintillator 20b, in certain other implementations, the first mirror 40a is upstream from the first scintillator 20a (see, e.g., FIG. 2D) and/or the second mirror 40b is upstream from the second scintillator 20b.

As shown in FIGS. 2B-2E, in certain implementations, the apparatus 100 further comprises an x-ray detector system 60 (e.g., one or more type-I x-ray imaging detectors; one or more type-II x-ray imaging detectors) configured to receive and use (e.g., for imaging) at least some of the x-rays of the x-ray beam 2 that propagate through both the first x-ray imaging detector 110a and the second x-ray imaging detector 110b. For example, as shown in FIGS. 2B-2E, the x-ray detector system 60 can be positioned sequentially along the x-ray propagation direction 13 (e.g., downstream from the first and second x-ray imaging detectors 110a,b). Examples of the x-ray detector system 60 can include, but are not limited to: a scintillator and an optical lens that does not have a hole or aperture (e.g., the x-ray detector system 60 is not configured to transmit x-rays); an x-ray camera; a flat panel detector; a pixel array photon counting detector; an amorphous Se pixel array detector. For example, a flat panel detector of the x-ray detector system 60 can comprise single-crystal, high efficiency scintillator microstructures having a thickness (e.g., greater than or equal to 250 microns; in a range of 150 microns to 250 microns; greater than or equal to 500 microns), configured to reduce (e.g., minimize) scattering or other factors that can otherwise degrade spatial resolution. While FIG. 2E shows that each of the first scintillator 20a and the second scintillator 20b is substantially perpendicular to the x-ray propagation direction 13, in certain other implementations, at least one of the first and second scintillators 20a,b is configured to be tilted to be non-normal to the x-ray propagation direction.

FIG. 2F schematically illustrates an example apparatus 100 comprising a plurality of x-ray imaging detectors 110a,b, . . . , n configured sequentially along an x-ray beam propagation direction 13 in accordance with certain implementations described herein. As shown in FIG. 2F, each x-ray imaging detector 110a,b, . . . , n comprises at least one scintillator 20a,b, . . . , n configured to allow a portion of the x-ray beam 2 incident on the at least one scintillator 20a,b, . . . , n to propagate through the at least one scintillator 20a,b, . . . , n and to generate visible light 22a,b, . . . , n in response to at least some of the x-rays of the x-ray beam 2. Each x-ray imaging detector 110a,b, . . . , n further comprises an objective 140a,b, . . . , n comprising at least one mirror 40a,b, . . . , n configured to allow propagation of at least a portion of the x-ray beam 2 through the objective 140a,b, . . . n and to reflect at least some of the visible light 22a,b, . . . , n from the at least one scintillator 20a,b, . . . , n in a direction non-parallel (e.g., substantially perpendicular) relative to the x-ray propagation direction 13 of the x-ray beam 2. Each x-ray imaging detector 110a,b, . . . , n further comprises at least one optical detector system 50a,b, . . . , n (e.g., each comprising a camera 52a,b, . . . , n and a lens 54a,b, . . . , n) configured to receive the visible light 22a,b, . . . , n reflected by the objective 140a,b, . . . , n and to generate an image in response to the received visible light 22a,b, . . . , n. While FIG. 2F shows that each of the at least one scintillator 20a,b, . . . , n is substantially perpendicular to the x-ray propagation direction 13, in certain other implementations, at least one of scintillators 20a,b, . . . , n is configured to be tilted to be non-normal to the x-ray propagation direction 13 (e.g., with the respective optical detector system 50a,b, . . . , n also tilted correspondingly relative to the x-ray propagation direction 13).

In certain implementations, as shown in FIG. 2F, each x-ray imaging detector 110a,b, . . . , n can comprise an objective enclosure 141a,b, . . . , n containing at least a portion of the at least one mirror 40a,b, . . . , n. The at least one mirror 40a,b, . . . , n can comprise a first mirror 142a,b, . . . , n (e.g., convex mirror), a second mirror 144a,b, . . . , n (e.g., concave mirror), and a third mirror 146a,b, . . . , n (e.g., substantially flat mirror). For example, both the first mirror 142a,b, . . . n and the second mirror 144a,b, . . . , n can be within the objective enclosure 140a,b, . . . , n (e.g., with the first mirror 142a,b, . . . , n downstream from the second mirror 144a,b, . . . , n) and the third mirror 146a,b, . . . , n can be outside the objective enclosure 140a,b, . . . , n (e.g., downstream from the first mirror 142a,b, . . . , n). Each of the first mirror 142a,b, . . . , n, the second mirror 144a,b, . . . , n, and the third mirror 146a,b, . . . , n can comprise an x-ray transmissive region 42a,b, . . . , n configured to allow at least a portion of the x-ray beam 2 to propagate therethrough.

The first mirror 142a,b, . . . , n can be configured to receive and reflect the visible light 22a,b, . . . , n from the at least one scintillator 20a,b, . . . , n to the second mirror 144a,b, . . . , n. The second mirror 144a,b, . . . , n can be configured to receive and reflect the visible light 22a,b, . . . , n from the first mirror 142a,b, . . . , n to the third mirror 146a,b, . . . , n. For example, the first mirror 142a,b, . . . , n can comprise an aperture configured to allow the visible light 22a,b, . . . , n to propagate through the first mirror 142a,b, . . . , n from the second mirror 144a,b, . . . , n to the third mirror 146a,b, . . . , n. The third mirror 146a,b, . . . , n can be configured to receive and reflect the visible light 22a,b, . . . , n (e.g., by an angle substantially equal to 45 degrees) to the optical detector system 50a,b, . . . , n.

While FIG. 2F shows each of the x-ray imaging detectors 110a,b, . . . n as having substantially identical structures to one another (e.g., each comprises a type-II x-ray imaging detector), in certain other implementations, two or more of the x-ray imaging detectors 110a,b, . . . n have different structures from one another (e.g., at least one type-I x-ray imaging detector and at least one type-II x-ray imaging detector).

In certain implementations, the scintillator materials of the at least one scintillator 20a,b, . . . , n are configured to have sufficiently high x-ray absorption of the x-rays of the x-ray beam 2 in a predetermined energy band, based on the absorption edges of a high atomic number (Z) elements of the scintillator materials. For example, ten x-ray imaging detectors 110, each with a 5-micron LSO scintillator 20 and a reflective microscope objective 140 with 0.5 NA, can be used for sub-micron resolution imaging with an effective total 50-micron LSO scintillator thickness with ten type-I and/or type-II x-ray imaging detectors. In certain implementations, the sequentially arranged plurality of x-ray imaging detectors 110 can offer up to 10× imaging speed/throughput as compared to a single x-ray imaging detector with the same scintillator 20 and the same optical lens system 30. In certain implementations, the LSO scintillator can be replaced by other scintillator materials or other thickness, or a different optical lens system can be used. For example, five x-ray imaging detectors 110 each with a 150-micron LSO scintillator and a 0.14 NA objective can be used for 6-micron resolution imaging with an effective 750-micron LSO scintillator thickness, which can offer up to 5× imaging speed/throughput compared to a single x-ray imaging detector with the same scintillator 20 and the optical lens system 30.

In certain implementations, the sequentially arranged plurality of x-ray imaging detectors 110 are configured to obtain a spatial resolution less than 10 microns (e.g., less than 3 microns; less than 1 micron) by utilizing scintillator materials emitting short wavelength light (e.g., less than 400 nm wavelength) and/or utilizing high NA lens systems (e.g., NA greater than 0.1, greater than 0.5, or greater than 0.7), and/or utilizing thin scintillators (e.g., thicknesses along the x-ray propagation direction 13 that are less than 5 microns). In certain implementations, the sequentially arranged plurality of x-ray imaging detectors 110 are configured to obtain a spatial resolution less than 10 microns (e.g., less than 3 microns; less than 1 micron) and another x-ray detector system 60 (e.g., a flat panel detector; pixel array photon counting detector; a pixel array amorphous Se detector) is positioned sequentially along the x-ray propagation direction 13 (e.g., downstream from the plurality of x-ray imaging detectors 110) and is configured for high x-ray detection efficiency with coarser spatial resolution (e.g., greater than 10 microns; greater than 25 microns; greater than 50 microns).

In certain implementations, the sequentially arranged plurality of x-ray imaging detectors 110 comprise different scintillation materials and thicknesses to obtain predetermined detection efficiency for x-rays within predetermined energy bandwidths. For example, LSO scintillators absorb more strongly for x-rays of energies greater than 63.3 keV (which corresponds to the K absorption edge of lutetium) than do CsI scintillators of the same thickness. In certain implementations, the LSO scintillator can be replaced by other scintillator materials or other thickness to obtain high x-ray detection efficiency for x-rays of another predetermined energy range (e.g., GaGG for x-rays of energies in a range of 50.3 keV to 63 keV; YAG for x-rays of energies in a range of 17 keV to 35 keV; GLO for x-rays of energies in a range of 50.3 keV to 100 keV). In certain implementations, at least two scintillators 20 of different materials (e.g., YAG; CsI; GaGG; LSO; GLO) are used for their different spectral absorption efficiency responses as the x-ray absorption efficiency of a scintillator depends on the scintillator material (e.g., x-rays of energies higher than an absorption edge of a key atomic element in the scintillator are more strongly absorbed than x-rays of energies below the absorption edge). For example, three x-ray imaging detectors 110, each having a scintillator 20 with a scintillator material of CsI, GaGG, and LSO, respectively, can provide improved x-ray absorption for x-rays of energies across the range of 10 keV to 160 keV, as compared to all three x-ray imaging detectors 110 using the same scintillator material. In certain implementations, a plurality of x-ray imaging detectors 110 with two or more different scintillator materials are used with another x-ray detector system 60 (e.g., a flat panel detector; pixel array photon counting detector; a pixel array amorphous Se detector) and the recorded images can be processed to obtain spatially resolved spectral absorption information of an object being imaged. In certain implementations, at least one spectral filter comprising a high atomic number element and a predetermined thickness is positioned upstream of an x-ray imaging detector 110 to change the spectral response of the x-ray imaging detector 110. In certain implementations, another x-ray detector system 60 (e.g., a flat panel detector; pixel array photon counting detector; a pixel array amorphous Se detector) is used together with the plurality of x-ray imaging detectors 110 to obtain additional detection efficiency over a predetermined energy bandwidths (e.g., use of energy thresholds in a pixel array photon counting detector).

In certain implementations, the plurality of x-ray imaging detectors 110, with or without another x-ray detector system 60 (e.g., a flat panel detector; pixel array photon counting detector; a pixel array amorphous Se detector) is configured with predetermined separation distances between adjacent x-ray imaging detectors 110 along the x-ray beam propagation direction 13 to obtain angular divergence information of the x-ray beam 2, effectively acting as a 3D x-ray detector that records both positional information as well as angular information.

Various applications are compatible with certain such implementations. For example, such arrangement can be used for x-ray imaging of an object with absorption, and/or scattering (e.g., darkfield), and/or refraction contrast. For another example, certain implementations can be used to record the origin of x-rays diffracted by crystallites in an object illuminated by a focused x-ray beam 2, either a point focus x-ray beam 2 or a sheet focus x-ray beam 2. Using a 3D x-ray detector, a diffracted x-ray beam (e.g., having a narrow energy band) can be triangulated together with the focused x-ray beam 2 to localize the origin of a diffracted x-ray beam. Multiple diffracted beams can be recorded. For example, the scintillator material and the thickness of the scintillator 20 of the upstream x-ray imaging detector 110 can be configured such that the scintillator 20 has an x-ray transmission greater than 5% for the diffracted x-rays so that the transmitted diffracted x-rays can be recorded by a downstream detector. In certain implementations, the separation distance and the spatial resolution of the x-ray imaging detectors 110 can determine the precision for localizing the origin of a diffracted x-ray beam. In certain implementations in which the energies of the diffracted x-ray beams are less than 15 keV, scintillators of low atomic number (Z) materials (e.g., CaF₂) or scintillators based on high Z materials (e.g., Lu, Gd, Y, CsI, and Cd) with thicknesses less than 50 microns can be used. In certain implementations, a plurality of different scintillator materials with predetermined thicknesses can be used to obtain energy information of the diffracted x-ray beam.

In certain implementations, the scintillator 20 of the x-ray imaging detector 110 closest to an object (e.g., sample being analyzed) is placed as close to the object as possible (e.g., less than 1 mm, less than 5 mm, less than 20 mm, less than 100 mm). In certain implementations, the scintillators 20 of at least two x-ray imaging detectors 110, for example, with another x-ray detector system 60 (e.g., a flat panel detector; pixel array photon counting detector; a pixel array amorphous Se detector) are configured with a separation distance between the scintillator 20 of one x-ray imaging detector 110 and the scintillator 20 of another adjacent x-ray imaging detector 110 along the x-ray propagation direction 13 greater than 10 mm (e.g., greater than 100 mm; greater than 1000 mm).

In certain implementations, at least two x-ray imaging detectors 110 or at least one x-ray imaging detector 110 and another x-ray detector system 60 (e.g., a flat panel detector; pixel array photon counting detector; a pixel array amorphous Se detector) are configured with predetermined separation distances between adjacent x-ray detectors so that the pixel size projected on an object in a projection x-ray microscope geometry is substantially equal. As scattering and/or refraction of incident x-rays by an object leads to angular change, an x-ray imaging detector 110 placed close to the object will not be sensitive to the angular change while an x-ray imaging detector 110 placed farther away from the object will be more sensitive to the angular change. By recording and processing x-ray images taken by two or more x-ray imaging detectors 110 and/or a flat panel, a pixel array photon counting detector, a pixel array amorphous Se detector, images with absorption, phase, and scattering contrast can be obtained.

In certain implementations, at least two x-ray imaging detectors, or at least one x-ray imaging detector and another x-ray detector system 60 (e.g., a flat panel detector; pixel array photon counting detector; a pixel array amorphous Se detector) are configured with field-of-view differences greater than 1.5×, greater than 3×, or greater than 10×. In certain implementations, the different fields-of-view are centered to each other. In certain implementations, the centers of the different fields-of-view have an offset relative to one another. In certain implementations, a field-of-view image with a smaller area has a higher spatial resolution than a field-of-view image with a larger area. In certain implementations, the smaller field-of-view image with higher resolution is used to improve the spatial resolution of the larger field-of-view image with coarser resolution.

In certain implementations, at least two x-ray imaging detectors 110 are configured to have the same pixel resolution as one another on a plane substantially perpendicular to the x-ray beam propagation direction 13 and are shifted by an integer fraction of the pixel resolution in a direction substantially perpendicular to the x-ray beam propagation direction 13 (e.g., the integer equal to the number of x-ray imaging detectors 110). In certain implementation, the x-ray imaging detectors 110 are configured to have the same pixel resolution as one another on a plane substantially perpendicular to the x-ray beam propagation direction 13 in the sample and are shifted by an integer fraction of the pixel resolution in two substantially orthogonal directions substantially perpendicular to the x-ray beam propagation direction 13 (e.g., with the integer equaling the number of x-ray imaging detectors 110 in the respective direction). In certain implementations, at least two x-ray imaging detectors 110 can be displaced (e.g., shifted) relative to each other in a direction substantially perpendicular to the x-ray beam propagation direction 13. Certain such implementations can concurrently record x-ray transmission images and can use resolution image processing algorithms to obtain better spatial resolution than a single x-ray imaging detector (e.g., by a factor up to the number of x-ray imaging detectors 110 in the respective direction).

In certain implementations, higher resolution in a predetermined direction is used (e.g., direction along a surface normal of an electronic package). To minimize pixel resolution change along the x-ray beam propagation direction 13 within a sample, small separations between the scintillators 20 of the x-ray imaging detectors 110 can be used. Images recorded by these x-ray imaging detectors 110 can be processed using algorithms developed for super resolution by collecting and processing x-ray images before and after shifting (e.g., dithering) a detector 50.

Certain implementations described herein provide one or more features, examples of which include but are not limited to:
Increasing imaging throughput by allowing x-rays transmitted through a thin scintillator 20 to be used for imaging with at least one of: a substantially similar x-ray camera with an aperture, a substantially similar x-ray camera without an aperture, a flat panel detector, a pixel array photon counting detector, an amorphous Se pixel array detector. Certain implementations can use a plurality of similar x-ray cameras configured along the x-ray beam 2 to facilitate high resolution x-ray imaging: high NA for high spatial resolution with short depth-of-focus and a thin scintillator 20 with low x-ray absorption and low detector efficiency.
Concurrent imaging of small field-of-view with high resolution and large field-of-view with coarser resolution. For example, by using high resolution images that overlap with large field-of-view images with coarser resolution, the resolution of the large field-of-view images can be improved.
Obtaining material composition information by utilizing different scintillator properties (e.g., materials and thickness) of x-ray cameras and flat panels or photoconductor materials of photon counting detectors. In certain implementations, the scintillator properties can be used in conjunction with the energy windows of a photon counting detector.
Concurrently imaging with absorption contrast, refraction, and darkfield imaging based on the distance of a camera from the sample as angular change due to scattering and refraction by a feature can be measured by the shift of the image position on a camera/detector, with plural cameras and/or detectors configured with predetermined distances from the sample. For example, a camera placed close to the sample can record mostly the absorption contrast image, a camera/detector position away from the sample can contain a superposition of images from scattering, refraction and darkfield images. By using predetermined distances, the recorded images can be processed according to predetermined algorithms to obtain darkfield, absorption, and phase contrast images.
3D camera to track origins of diffracted x-ray beams, which are generally monochromatic, for performing 3D x-ray diffraction tomography or microscopy by selecting appropriate distances between at least two x-ray imaging detectors to be in a range of 2 mm to 300 mm (e.g., in a range of 5 mm to 100 mm; in a range of 10 mm to 50 mm).
Improving signal-to-noise ratio (S/N) in some images with optimal energy bandwidth and lower radiation dose as compared to a single integrated detector.
Switching scintillator materials and thicknesses in response to sample composition and size.
Smaller scintillators in at least one direction.
Smaller aperture s(e.g., slits or 2D aperture) for high resolution.

### Applications in X-ray Imaging Systems

In certain implementations, a projection x-ray imaging system or a laminography system (e.g., microscope) comprises an apparatus 10,100 in accordance with certain implementations described herein. The system can further comprise an x-ray source for generating x-rays for illuminating an object and can use the apparatus 10,100 as disclosed herein for recording x-rays transmitted through the object. In certain implementations, the upstream-most x-ray imaging detector 110 (e.g., closest to the object) comprises a scintillator 20 and a scintillator holder having one dimension that is comparable or slightly larger than the field-of-view of the x-ray imaging detector 110 in one direction (e.g., to allow an extended flat sample to rotate). In certain implementations, the x-ray source comprises multiple operator-selectable target materials to select x-rays with certain spectral characteristics. In certain implementations, the apparatus 10,100 is configured to obtain an x-ray absorption contrast image and x-ray scattering (e.g., darkfield) image and/or x-ray phase contrast image concurrently.

Certain implementations are configured for imaging and inspection of hybrid bonding of semiconductor packaging. A first x-ray imaging detector 110a configured with high spatial resolution (e.g., less than 1 micron; less than 3 microns) can be placed close to a test sample and a second x-ray detector 60 (e.g., a flat panel detector, pixel array photon counting detector, or a pixel array amorphous Se detector) can be placed at a distance such that the projected pixel size of the second detector 60 at the sample is comparable to that of the first x-ray imaging detector 110 placed close to the sample. In another implementation, at least one x-ray imaging detector 110 with a spatial resolution better than 10 microns (e.g., better than 5 microns) is configured between the high resolution first x-ray imaging detector 110 and the second detector 60 and the second detector 60 is configured with a resolution comparable with a resolution of the first x-ray imaging detector 110 placed close to the sample. For imaging hybrid bonding integrated circuit (IC) packages, parameters of an x-ray laminography imaging system can be: an x-ray source with a target material producing characteristic line around 20 keV (e.g., Mo, Rh, Pd, and Ag), an x-ray imaging detector 110 with a thin scintillator 20 (e.g., thickness less than 50 microns; less than 20 microns; less than 10 microns) comprising a scintillator material with high x-ray absorption efficiency for x-rays of energies in a range of 15 keV to 30 keV, and a pixel array amorphous Se detector 60 with Se thickness in a range of 100 microns to 400 microns (e.g., approximately equal to 200 microns) placed at a distance such that a projected pixel size of the pixel array amorphous Se detector 60 at the sample position is small (e.g., less than or equal to 3 microns; less than or equal to 1 micron) and a laminography slant angle (e.g., the angle between the x-ray imaging beam axis and a plane perpendicular to the sample rotation axis) in a range of 5 degrees to 45 degrees (e.g., in a range of 10 degrees to 30 degrees). Additional x-ray imaging detectors 110 between the first x-ray imaging detector 110 and the pixel array amorphous Se detector 60 can be added to improve imaging speed and/or additional materials information.

In certain implementations, the apparatus 10,100 is configured to achieve a predetermined spatial resolution (e.g., better than 5 microns; better than 2 microns; better than 1 micron) in a predetermined direction (e.g., along the surface normal direction of a semiconductor electron package or a semiconductor wafer). Certain implementations comprise an x-ray source with a source size along the predetermined direction that is comparable to or smaller than the predetermined spatial resolution (e.g., 5 microns; 2 microns; 1 micron). In certain implementations, the plurality of x-ray imaging detectors 110 are configured with spatial resolutions comparable to or finer than the predetermined spatial resolution along the predetermined direction. In certain implementations, at least two x-ray imaging detectors 110 are configured to have the same pixel resolution as one another on a plane substantially perpendicular to the x-ray beam propagation direction 13 and shifted by an integer fraction of the pixel resolution in the predetermined direction (e.g., the integer equal to the number of x-ray imaging detectors 110). In certain implementation, the plurality of x-ray imaging detectors 110 are configured to have the same pixel resolution as one another on a plane substantially perpendicular to the x-ray beam propagation direction 13 in the sample and shifted by an integer fraction of the pixel resolution in the predetermined direction (e.g., with the integer equaling the number of x-ray imaging detectors 110 in the respective direction).

In certain implementations for x-ray imaging of 3D integration of the semiconductor chips using hybrid bonding, the apparatus 10,100 is configured with at least one x-ray imaging detector 110 with a thin scintillator 20 (e.g., YAG or CsI scintillator having a thickness less than or equal to 200 microns, less than or equal to 50 microns, or less than or equal to 10 microns) and an amorphous Se pixel array detector 60 downstream of the at least one x-ray imaging detector 110. In certain implementations, the apparatus 10,100 is configured in a laminographic geometry to image 3D integration of the semiconductor chips using hybrid bonding.

Various implementations disclosed herein can be used for x-ray imaging. Some additional features for x-ray imaging provided by certain implementations described herein include but are not limited to: automated detection of source and sample position movement by having the positions of the x-ray imaging detectors 110 fixed relative to one another while the sample and/or the x-ray source are movable during image collection; identifying and reducing (e.g., minimizing) the effect of scintillator defects (e.g., because it is unlikely that the pixels of different scintillators 20 along the x-ray beam propagation direction 13 have defects that are aligned with one another).

### X-ray Diffraction Microscopy

Certain implementations described herein provide an apparatus 10,100 for x-ray diffraction microscopy comprising an x-ray source for generating x-rays for illuminating an object, an x-ray focusing optical system for generating a focused x-ray beam in at least one direction (e.g., a focused pencil beam, a focused fan beam), and a sequential array of x-ray imaging detectors 110 as disclosed herein for recording x-ray beams diffracted by the object. In certain implementations, the apparatus 10,100 comprises an x-ray imaging detector 110 with resolution better than 10 microns (e.g., better than 5 microns, better than 2 microns) and is configured to be placed close to an object (e.g., the upstream-most x-ray imaging detector 110 of the apparatus 10,110), and at least one of the x-ray imaging detectors 110 is configured to be placed at a predetermined distance from the object and the upstream-most x-ray imaging detector 110 of the apparatus 10,100 (e.g., greater than 5 mm, greater than 10 mm, greater than 50 mm, greater than 200 mm). A large predetermined distance can provide better determination of the origin of diffracted beams than does a small predetermined distance. The scintillator 20 of the upstream-most x-ray imaging detector 110 can be configured to have at least 5% x-ray transmission for diffracted x-rays. In certain implementations, more than three (e.g., more than ten) x-ray imaging detectors 110 configured sequentially along the x-ray propagation direction 13 are used. In certain implementations, at least two x-ray imaging detectors 110 are separated by a distance greater than 5 mm (e.g., greater than 20 mm).

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements, and/or steps are in any way required for one or more implementations. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Conjunctive language such as the phrase “at least one of X, Y, and Z,” unless specifically stated otherwise, is to be understood within the context used in general to convey that an item, term, etc. may be either X, Y, or Z. Thus, such conjunctive language is not generally intended to imply that certain implementations require the presence of at least one of X, at least one of Y, and at least one of Z.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by +5 degrees, by +2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by +1 degree, or by ±0.1 degree. The ranges disclosed herein also encompass any and all overlap, sub-ranges, and combinations thereof. Language such as “up to,” “at least,” “greater than,” less than,“ ”between,“ and the like includes the number recited. As used herein, the meaning of ”a,“ ”an,“ and ”said“ includes plural reference unless the context clearly dictates otherwise. While the structures and/or methods are discussed herein in terms of elements labeled by ordinal adjectives (e.g., first, second, etc.), the ordinal adjectives are used merely as labels to distinguish one element from another, and the ordinal adjectives are not used to denote an order of these elements or of their use.

Various configurations have been described above. It is to be appreciated that the implementations disclosed herein are not mutually exclusive and may be combined with one another in various arrangements. Although this invention has been described with reference to these specific configurations, the descriptions are intended to be illustrative of the invention and are not intended to be limiting. Various modifications and applications may occur to those skilled in the art without departing from the true spirit and scope of the invention. Thus, for example, in any method or process disclosed herein, the acts or operations making up the method/process may be performed in any suitable sequence and are not necessarily limited to any particular disclosed sequence. Features or elements from various implementations and examples discussed above may be combined with one another to produce alternative configurations compatible with implementations disclosed herein. Various aspects and advantages of the implementations have been described where appropriate. It is to be understood that not necessarily all such aspects or advantages may be achieved in accordance with any particular implementation. Thus, for example, it should be recognized that the various implementations may be carried out in a manner that achieves or optimizes one advantage or group of advantages as taught herein without necessarily achieving other aspects or advantages as may be taught or suggested herein.

1. An apparatus comprising:
at least one scintillator configured to allow first x-rays of an x-ray beam to propagate through the at least one scintillator and to generate visible light in response to second x-rays of the x-ray beam;
at least one optical system configured to allow at least a first portion of the first x-rays to propagate through the at least one optical system;
at least one mirror configured to allow at least a second portion of the first portion of the first x-rays to propagate through the at least one mirror and to reflect at least some of the visible light from the at least one optical system in a direction non-parallel relative to an x-ray propagation direction of the first x-rays propagating through the at least one optical system and the at least one mirror; and
a plurality of active elements configured to receive the visible light reflected by the at least one mirror.

2. The apparatus of claim 1, wherein the at least one optical system comprises at least one aperture configured to allow the first portion of the first x-rays to propagate through the at least one optical system.

3. The apparatus of claim 1, wherein the at least one optical system is downstream from the at least one scintillator.

4. The apparatus of claim 1, wherein the x-ray beam comprises an x-ray image, and the at least one scintillator is configured to convert the second x-rays of the x-ray beam to an optical image.

5. The apparatus of claim 1, wherein the at least one mirror is downstream from the at least one optical system.

6. The apparatus of claim 1, wherein the plurality of active elements comprise pixels of a CCD camera or a CMOS camera.

7. The apparatus of claim 1, further comprising at least one lens configured to receive and focus the visible light reflected from the at least one mirror onto the plurality of active elements.

8. The apparatus of claim 1, further comprising an x-ray detector system positioned downstream from the at least one optical detector system.

9. An apparatus comprising:
a first x-ray imaging detector and a second x-ray imaging detector, the first x-ray imaging detector and the second x-ray imaging detector positioned sequentially along a propagation direction of an x-ray beam; and
at least one aperture configured to allow x-rays to propagate through the first x-ray imaging detector to the second x-ray imaging detector.

10. The apparatus of claim 9, wherein at least one of the first x-ray imaging detector and the second x-ray imaging detector comprises a type-I x-ray imaging detector.

11. The apparatus of claim 9, wherein at least one of the first x-ray imaging detector and the second x-ray imaging detector comprises a type-II x-ray imaging detector.

12. The apparatus of claim 9, wherein at least one of the first x-ray imaging detector and the second x-ray imaging detector comprises:
a scintillator configured to be irradiated by the x-ray beam propagating along the propagation direction, to generate visible light in response to at least some x-rays of the x-ray beam, and to allow at least some x-rays of the x-ray beam to propagate through the scintillator;
a mirror configured to receive at least some of the visible light from the scintillator, and to allow at least some x-rays of the x-ray beam that propagate through the scintillator to propagate through the mirror.

13. The apparatus of claim 12, wherein the at least one of the first x-ray imaging detector and the second x-ray imaging detector further comprises:
a lens configured to receive and focus at least some of the visible light reflected by the mirror; and
a camera configured to receive the focused visible light from the lens.

14. An apparatus comprising:
a first x-ray imaging detector and a second x-ray imaging detector positioned sequentially along a propagation direction of an x-ray beam, wherein at least one of the first x-ray imaging detector and the second x-ray imaging detector comprises:
a scintillator configured to be irradiated by the x-ray beam propagating along the propagation direction, to generate visible light in response to at least some x-rays of the x-ray beam, and to allow at least some x-rays of the x-ray beam to propagate through the scintillator;
an optical system configured to receive at least some of the visible light from the scintillator, and to allow at least some x-rays of the x-ray beam that propagate through the scintillator to propagate through the optical system;
a mirror configured to reflect at least some of the visible light from the optical system in a direction non-parallel relative to the propagation direction of the x-ray beam, and to allow at least some x-rays of the x-ray beam that propagate through the optical system to propagate through the mirror; and
a detector system configured to receive at least some of the visible light reflected by the mirror, and to generate an image in response to the received at least some of the visible light.

15. The apparatus of claim 14, wherein at least one of the optical system and the mirror comprises at least one aperture configured to allow x-rays to propagate from the first x-ray imaging detector to the second x-ray imaging detector.

16. The apparatus of claim 14, wherein the detector system comprises a camera and a lens configured to receive and focus at least some of the visible light from the mirror onto the camera.

17. The apparatus of claim 14, wherein at least one of the first x-ray imaging detector and the second x-ray imaging detector comprises:
a second scintillator configured to be irradiated by the x-ray beam propagating along the propagation direction of the x-ray beam, to generate second visible light in response to at least some x-rays of the x-ray beam, and to allow at least some x-rays of the x-ray beam to propagate through the second scintillator;
a second optical system configured to receive at least some of the second visible light from the second scintillator, and to allow at least some x-rays of the x-ray beam that propagate through the second scintillator to propagate through the second optical system;
a second mirror configured to reflect at least some of the second visible light from the second optical system in a second direction non-parallel relative to the propagation direction of the x-ray beam, and to allow at least some x-rays of the x-ray beam that propagate through the second optical system to propagate through the second mirror; and
a second detector system configured to receive at least some of the second visible light reflected by the second mirror, and to generate a second image in response to the received at least some of the second visible light.

18. The apparatus of claim 17, wherein at least one of the second optical system and the second mirror comprises an aperture.

19. The apparatus of claim 17, wherein the second detector system comprises a second camera and a second lens configured to receive and focus at least some of the second visible light from the second mirror onto the second camera.

20. The apparatus of claim 14, wherein the first x-ray imaging detector and the second x-ray imaging detector comprises at least one type-I or type-II x-ray imaging detector, and the apparatus further comprises at least one additional detector selected from the group consisting of: a type-II x-ray imaging detector, a flat panel detector, a pixel array photon counting detector, and an amorphous Se pixel array detector.

21. The apparatus of claim 14, wherein the first x-ray imaging detector comprises a first scintillator material, and the second x-ray imaging detector comprises a second scintillator material different from the first scintillator material, the first scintillator material and the second scintillator material having predetermined x-ray absorption properties that are different from one another.

22. The apparatus of claim 21, wherein the first scintillator material and the second scintillator material are separated from one another by a separation distance along the propagation axis of the x-ray beam greater than 5 mm.

23. The apparatus of claim 21, wherein the first x-ray imaging detector has a first field-of-view, and the second x-ray imaging detector has a second field-of-view, wherein a ratio of the first field-of-view to the second field-of-view is in a range of 1 to 50.

24. An apparatus comprising:
an x-ray source configured to emit an x-ray beam that impinges a sample; and
a plurality of x-ray imaging detectors configured to receive x-rays of the x-ray beam that are transmitted through the sample, the plurality of x-ray imaging detectors configured to provide both positional information and angular information of structures within the sample.

25. The apparatus of claim 24, wherein the plurality of x-ray imaging detectors has predetermined separation distances between adjacent x-ray imaging detectors along a propagation direction of the x-ray beam.

26. The apparatus of claim 24, configured for characterizing hybrid bonding of semiconductor packaging.

27. The apparatus of claim 24, configured to provide a predetermined spatial resolution in a direction along a surface normal direction of the sample.
